(19) United States
(12) Patent Application Publication
(10) Pub. No.: US 2011/0063281 A1
(43) Pub. Date: Mar. 17, 2011

(54) PIXEL ARRAY AND DRIVING METHOD THEREOF AND FLAT PANEL DISPLAY

(75) Inventors: Chao-Ching Hsu, Taoyuan County (TW); Wei-Cheng Lin, Taichung County (TW); Yu-Chun Tsai, Chiayi County (TW)

(73) Assignee: AU OPTRONICS CORPORATION, Hsinchu (TW)

(21) Appl. No.: 12/603,579

(22) Filed: Oct. 21, 2009

(30) Foreign Application Priority Data
Sep. 14, 2009 (TW) 98130910

(51) Int. Cl. G09G 5/00

(52) U.S. Cl. 345/213; 345/204

(57) ABSTRACT

A pixel array, a driving method thereof and a flat panel display using the same are provided. The pixel array includes a first, a second, a third, and a fourth scan lines. A plurality of pixels is disposed between the first and the second scan lines. A plurality of pixels is disposed between the third and the fourth scan lines. In a first frame period, a gate driving circuit sequentially provides a driving signal to the first, the second, the fourth and the third scan lines. In a second frame period, the gate driving circuit sequentially provides the driving signal to the second, the first, the third and the fourth scan lines.

### CROSS-REFERENCE TO RELATED APPLICATION

This application claims the priority benefit of Taiwan application serial no. 98130910, filed Sep. 14, 2009. The entirety of the above-mentioned patent application is hereby incorporated by reference herein and made a part of specification.

### BACKGROUND OF THE INVENTION

1. Field of the Invention

The present invention relates to a flat panel display. More particularly, the present invention relates to a half source driving (HSD) panel pixel array and a driving method thereof.

2. Description of Related Art

Along with development of large-scale display panels, in various pixel array structures of current liquid crystal display (LCD) panels, there is a so-called half source driving (HSD) structure. According to the HSD structure, a number of data lines can be reduced to a half, so that a price of a source driver is accordingly reduced. In detail, in a pixel array of the HSD structure, two adjacent sub-pixels share one data line, so that the number of the data lines can be reduced to a half.

However, in the HSD pixel array, to maintain a same frame frequency, reduction of the source drivers can result in a fact that a charge time of each of the sub-pixels (which is 8-9 us) is less than a half of that of a conventional structure (which is, 18-19 us). Therefore, a charge rate becomes an important issue. As a resolution of the pixel array increases, the charge time of the high resolution HSD pixel array becomes shorter. Regarding a 1600×900 resolution, the charge time of each of the sub-pixels is about 6-7 us, only.

The larger the size of the pixel array is, the longer the lengths of the data lines (which is also referred to as source lines) and scan lines (which is also referred to as gate lines) thereof are, and the more obvious a signal delay effect is. Since the charge time of the HSD pixel array is shorter than that of the conventional structure, the signal delay effect of the data line and the scan line generally may influence gray levels of a part of the sub-pixels. For example, at a tail end of the data line, a data line delay can lead to different charge rates of odd sub-pixels and even sub-pixels, so that a display defect of bright/dark lines is generated. Moreover, at a tail end of the scan line, a scan line delay leads to a result that a gate is not disabled during a polarity conversion, so that the defect of the bright/dark lines is generated due to a charge error of the even sub-pixels.

### SUMMARY OF THE INVENTION

The present invention is directed to a pixel array and a driving method thereof, and a flat panel display using the driving method, so as to mitigate a display defect of bright/dark lines.

The present invention provides a pixel array including a first pixel row, a second pixel row, a plurality of data lines and a gate driving circuit. The first pixel row includes a first scan line, a second scan line, a plurality of first pixels, and a plurality of second pixels. The first pixels and the second pixels are disposed between the first scan line and the second scan line in interlace. The second pixel row includes a third scan line, a fourth scan line, a plurality of third pixels, and a plurality of fourth pixels. The third pixels and the fourth pixels are disposed between the third scan line and the fourth scan line in interlace. The data lines are correspondingly coupled to the first pixels, the second pixels, the third pixels and the fourth pixels. The gate driving circuit is electrically coupled to the first scan line, the second scan line, the third scan line and the fourth scan line. Wherein, in a first frame period, the gate driving circuit sequentially provides a driving signal to the first, the second, the fourth and the third scan lines. In a second frame period, the gate driving circuit sequentially provides the driving signal to the second, the first, the third and the fourth scan lines.

The present invention provides a driving method for the aforementioned pixel array. The driving method includes following steps. In a first frame period, a driving signal is sequentially provided to the first, the second, the fourth and the third scan lines. In a second frame period, the driving signal is sequentially provided to the second, the first, the third and the fourth scan lines.

The present invention provides a flat panel display including a half source driving (HSD) panel, a gate driving circuit and a source driving circuit. The HSD panel includes a plurality of data lines, an a-th pixel row and a b-th pixel row. The a-th and the b-th pixel rows respectively include a plurality of first pixels, a plurality of second pixels, a first scan line and a second scan line, wherein the first pixels and the second pixels are disposed between the first scan line and the second scan line in interlace. The data lines are correspondingly coupled to the first pixels and the second pixels. A gate control terminal of the first pixels is coupled to the first scan line, and a gate control terminal of the second pixels is coupled to the second scan line. The gate driving circuit is electrically coupled to the a-th pixel row and the b-th pixel row. In a first frame period, the gate driving circuit drives the a-th pixel row in a sequence of “the first can line, the second scan line”, and drives the b-th pixel row in a sequence of “the second scan line, the first scan line”. In a second frame period, the gate driving circuit drives the a-th pixel row in a sequence of “the second can line, the first scan line”, and drives the b-th pixel row in a sequence of “the first scan line, the second scan line”. The source driving circuit is coupled to the data lines, wherein the source driving circuit drives the data lines according to a timing of the gate driving circuit.

According to the pixel array, the driving method thereof, and the flat panel display using the driving method, in a same frame period, the uneven bright/dark pixels are arranged in interlace in space, so as to mitigate a display defect of vertical bright/dark lines. Regarding a same pixel, the uneven bright/dark pixel is alternately presented on timing, so as to avoid presenting fixed bright/dark points on an image. Therefore, according to the present invention, the display defect of the bright/dark lines occurred when the HSD pixel array is driven by the conventional technique can be mitigated.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system block schematic diagram of a flat panel display according to an embodiment of the present invention.

FIG. 2 is a system block schematic diagram of a gate driving circuit of FIG. 1 according to an embodiment of the present invention.

FIG. 3 is a timing diagram of signal waveforms of FIG. 1 according to a first embodiment of the present invention.

FIG. 4 is a timing diagram of signal waveforms of FIG. 1 according to a second embodiment of the present invention.

FIG. 5 is a timing diagram of signal waveforms of FIG. 1 according to a fourth embodiment of the present invention.

### DESCRIPTION OF THE EMBODIMENTS

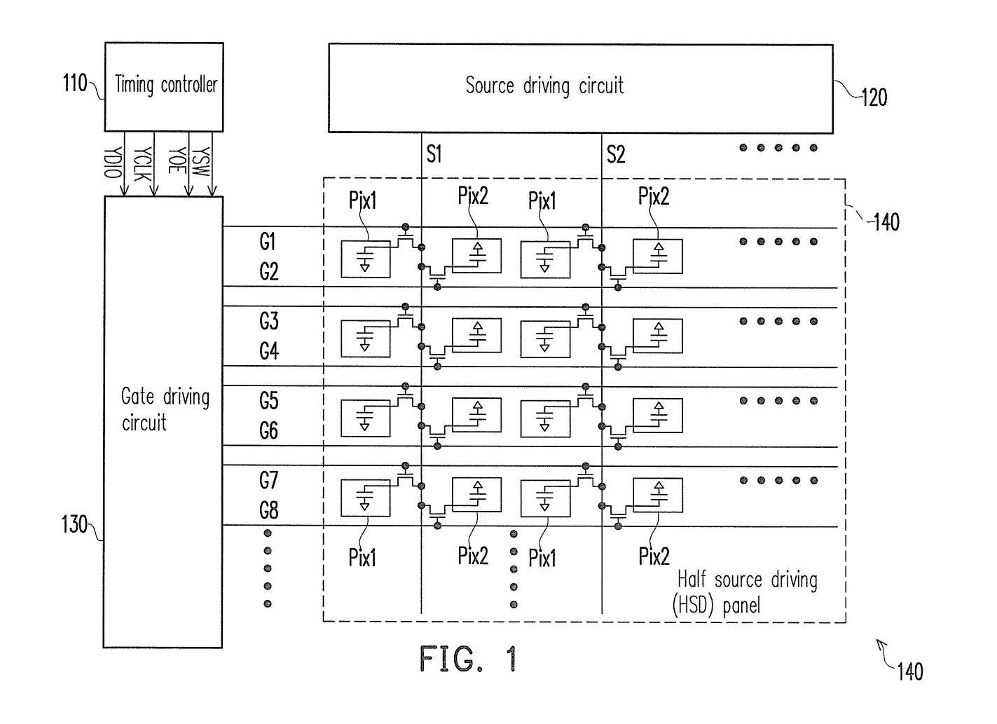

FIG. 1 is a system block schematic diagram of a flat panel display 100 according to an embodiment of the present invention. Referring to FIG. 1, the flat panel display 100 includes a timing controller 110, a source driving circuit 120, a gate driving circuit 130 and a half source driving (HSD) panel 140. In the present embodiment, the HSD panel 140 is a liquid crystal display (LCD) panel. According to a design requirement and a fabrication demand, the source driving circuit 120 and/or the gate driving circuit 130 can be disposed on a printed circuit board, a flexible circuit board, a glass substrate of the HSD panel 140. For example, the gate driving circuit 130 of the present embodiment is disposed on the glass substrate of the HSD panel 140 to form a pixel array module.

The HSD panel 140 includes a plurality of pixel rows (four pixel rows are illustrated in FIG. 1, though the present invention is not limited thereto), a plurality of data lines (two data lines S1 and S2 are illustrated in FIG. 1, though the present invention is not limited thereto). The data lines S1 and S2 are coupled to the source driving circuit 120. Base on a control of the timing controller 110, the source driving circuit 120 correspondingly drives the data lines S1 and S2 according to the timing of the gate driving circuit 130.

Each of the pixel rows includes two scan lines, a plurality of first pixels Pix1, and a plurality of second pixels Pix2. The first pixels Pix1 and the second pixels Pix2 are connected between the first scan line and the second scan line of the corresponding pixel row in interlace. The data lines S1 and S2 are coupled to the corresponding first pixels Pix1 and the second pixels Pix2. Gate control terminals of the first pixel Pix1 and the second pixels Pix2 are respectively coupled to the first scan line and the second scan line of the corresponding pixel row. Taking a first pixel row as an example, input terminals of the first pixels Pix1 and the second pixels Pix2 connected between the first scan line G1 and the second scan line G2 in interlace are coupled to the corresponding data lines S1 and S2. The first pixels Pix1 belonged to the first pixel row are coupled to the first scan line G1, and the gate control terminals of the second pixels Pix2 are coupled to the second scan line G2. Structures of the other pixel rows are substantially the same to the structure of the first pixel row. The pixels Pix1 and Pix2 are arranged on the HSD panel 140 in a matrix.

The gate driving circuit 130 is electrically connected to each of the pixel rows on the HSD panel 140. In a first frame period, according to a control signal YSW output by the timing controller 110, the gate driving circuit 130 drives one of or a plurality of the pixel rows (which is referred to as an a-th pixel row hereinafter) in a sequence of “the first scan line, the second scan line”, and drives another one of or a plurality of the pixel rows (which is referred to as a b-th pixel row hereinafter) in a sequence of “the second scan line, the first scan line”. Taking a third pixel row and a fourth pixel as an example, the gate driving circuit 130 drives the third pixel row in a sequence of “a scan line G5, a scan line G6”, and drives the fourth pixel row in a sequence of “a scan line G8, a scan line G7”.

In a second frame period, the gate driving circuit 130 drives the a-th pixel row in a sequence of “the second scan line, the first scan line”, and drives the b-th pixel row in a sequence of “the first scan line, the second scan line” according to the control signal YSW. Again, taking the third pixel row and the fourth pixel as an example, in the second frame period, the gate driving circuit 130 drives the third pixel row in a sequence of “the scan line G6, the scan line G5”, and drives the fourth pixel row in a sequence of “the scan line G7, the scan line G8”.

Regarding a certain pixel row (for example, the third pixel row of FIG. 1), since the first scan line (for example, the scan line G5) is first driven, and then the second scan line (for example, the scan line G6) is driven, the pixels on the firstly driven scan line G5 are probably insufficiently charged, and the pixels on the secondly driven scan line G6 are sufficiently charged, so that the even pixels (for example, the pixels Pix2) are relatively dark, and the odd pixels (for example, the pixels Pix1) are relatively bright. Conversely, in the pixel row (for example, the fourth pixel row in FIG. 1) adjacent to the above pixel row, since the second scan line (for example, the scan line G8) is first driven, and then the first scan line (for example, the scan line G7) is driven, the pixels on the scan line G8 are probably insufficiently charged, so that the odd pixels (for example, the pixels Pix1) are relatively dark, and the even pixels (for example, the pixels Pix2) are relatively bright. Therefore, the uneven bright/dark pixels can be arranged in interlace in space, so as to avoid a situation that the bright pixels are all located at the odd (or even) columns, and accordingly a display defect of vertical bright/dark lines can be mitigated.

Regarding a certain pixel row (for example, the first pixel row in FIG. 1), in the first frame period, since the first scan line (for example, the scan line G1) is first driven, and then the second scan line (for example, the scan lien G2) is driven, the pixels on the scan line G1 are probably insufficiently charged, and the pixels on the scan line G2 are sufficiently charged, so that the even pixels (for example, the pixels Pix2) are relatively dark, and the odd pixels (for example, the pixels Pix1) are relatively bright. Thereafter, in the second frame period, since the scan line G2 is first driven, and then the scan line G1 is driven, the pixels on the scan line G2 are probably insufficiently charged, and the pixels on the scan line G1 are sufficiently charged, so that the odd pixels Pix1 are relatively dark, and the even pixels Pix2 are relatively bright. Therefore, regarding a same pixel, the uneven bright/dark pixel is alternately presented on timing, so as to avoid presenting fixed bright/dark points on an image. Therefore, the display defect of the bright/dark lines occurred when the HSD pixel array is driven by the conventional technique can be mitigated.

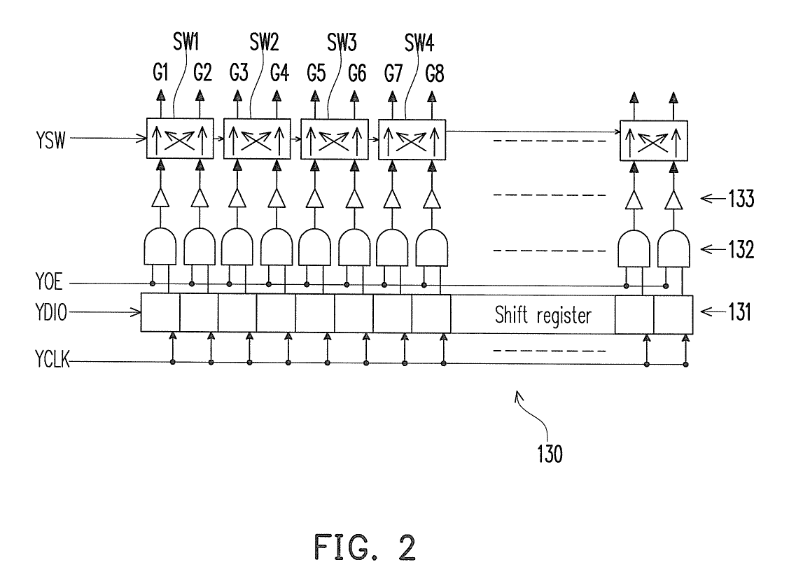

FIG. 2 is a system block schematic diagram of the gate driving circuit 130 of FIG. 1 according to an embodiment of the present invention. Referring to FIG. 2, the gate driving circuit 130 includes a plurality of shift registers 131, a plurality of AND gates 132, a plurality of buffers 133, and a plurality of switches (only five switches are illustrated in FIG. 1, and four of which are marked as SW1-SW4, though the present invention is not limited thereto). The switches SW1-SW4 respectively have a first, a second, a third and a fourth connecting terminals. According to a control of the control signal YSW, the first and the second connecting terminals are respectively connected to the third and the fourth connecting terminals, or the first and the second connecting terminals are respectively connected to the fourth and the third connecting terminals. The timing controller 110 provides a gate clock YCLK and a gate start pulse YDIO to the shift registers 131. A plurality of output terminals of the shift register 131 outputs gate pulses according to a trigger timing of the gate clock YCLK. The gate pulses respectively pass through the gates 132, the buffers 133 and the switches (for example, the switches SW1-SW4), and are transmitted to the corresponding scan lines (for example, the scan lines G1-G8) on the HSD panel 140. The gates 132 can modify widths of the gate pulses according to an enable signal YOE output by the timing controller 110.

Namely, under a control of the control signal YSW, the switch selectively couples an (a+1)-th output terminal and an (a+2)-th output terminal of the shift register 131 to the first and the second scan lines of the a-th pixel row on the HSD panel 140, respectively, or selectively couples the (a+1)-th output terminal and the (a+2)-th output terminal to the second and the first scan lines of the a-th pixel row, respectively. Taking the first pixel row of the HSD panel 140 as an example, the first switch SW1 respectively couples a first and a second output terminals of the shift register 131 to the scan lines G1 and G2, or respectively couples the first and the second output terminals of the shift register 131 to the scan lines G2 and G1 according to the control signal YSW. Taking the second pixel row of the HSD panel 140 as an example, the second switch SW2 respectively couples a third and a fourth output terminals of the shift register 131 to the scan lines G3 and G4, or respectively couples the third and the fourth output terminals of the shift register 131 to the scan lines G4 and G3 according to the control signal YSW. Operations of the switches SW3 and SW4 can be deduced according to the operations of the switches SW1 and SW2.

The aforementioned a-th pixel row and b-th pixel row can be respectively an odd pixel row and an even pixel row of the HSD panel 140. According to a design requirement, any of the pixel rows on the HSD panel 140 can be regarded as the aforementioned a-th pixel row (or the b-th pixel row). Moreover, the aforementioned first frame period and the second frame period can be respectively an odd frame or an even frame. According to a design requirement, one or a plurality of frames can be regarded as the aforementioned first frame period (or the second frame period). Embodiments are provided below for further descriptions.

### First Embodiment

In the present embodiment, a (2n+1)-th frame is regarded as the aforementioned first frame period, and a (2n+2)-th frame is regarded as the aforementioned second frame period, wherein n is an integer. Moreover, in the present embodiment, a (2 m+1)-th pixel row on the HSD panel 140 is regarded as the aforementioned a-th pixel row, and a (2 m+2)-th pixel row is regarded as the aforementioned b-th pixel row, wherein m is an integer.

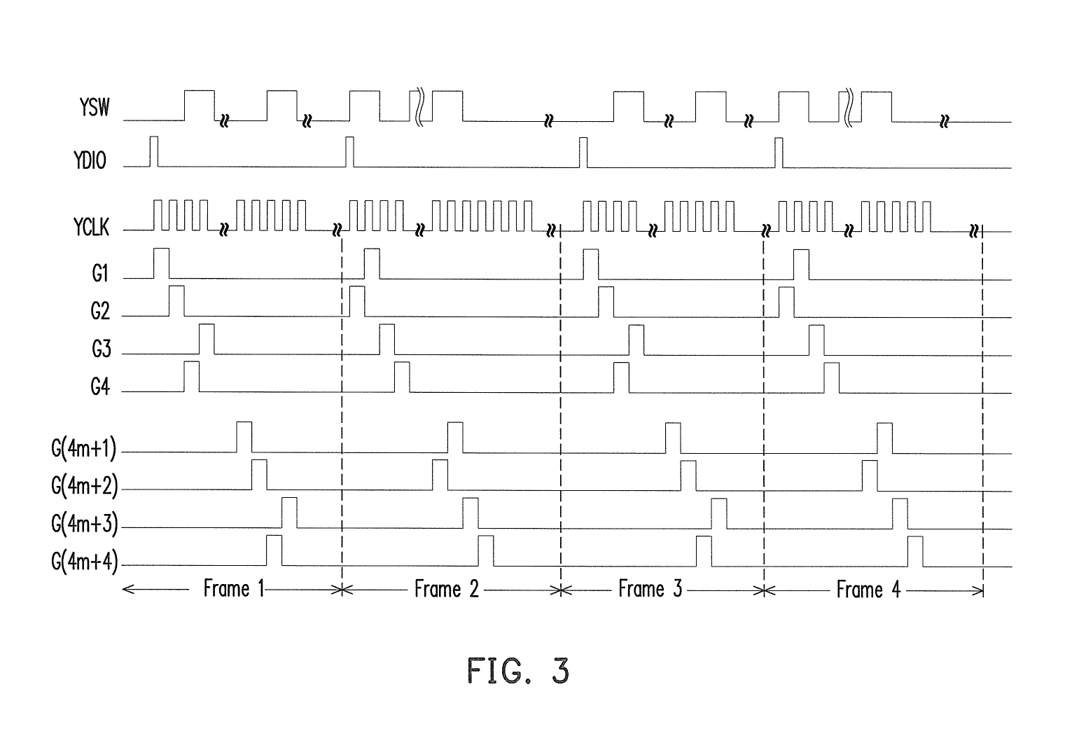

FIG. 3 is a timing diagram of signal waveforms of FIG. 1 according to an embodiment of the present invention. Referring to FIG. 1 and FIG. 3, in the (2n+1)-th frame (for example, a frame Frame1 or a frame Frame3 in FIG. 3), the gate driving circuit 130 provides a gate driving signal to the scan lines on the HSD panel 140 in a sequence of “the first scan line G1, the second scan line G2, the fourth scan line G4, the third scan line G3, . . . ”. Namely, the gate driving circuit 130 provides the gate driving signal to the scan lines on the HSD panel 140 in a sequence of “G(4m+1), G(4m+2), G(4m+4), G(4m+3)”. In the (2n+2)-th frame (for example, a frame Frame2 or a frame Frame4 in FIG. 3), the gate driving circuit 130 provides the gate driving signal to the scan lines on the HSD panel 140 in a sequence of “G(4m+2), G(4m+1), G(4m+3), G(4m+4)”.

### Second Embodiment

Similar to the first embodiment, the (2n+1)-th frame is regarded as the aforementioned first frame period, and the (2n+2)-th frame is regarded as the aforementioned second frame period. A difference between the present embodiment and the first embodiment is that a (4 m+1)-th pixel row on the HSD panel 140 is regarded as the aforementioned a-th pixel row, and a (4 m+3)-th pixel row is regarded as the aforementioned b-th pixel row. In the (2n+1)-th frame period, the (4 m+1)-th pixel row and the (4 m+2)-th pixel row on the HSD panel 140 are driven in a sequence of “the first scan line, the second scan line”, and the (4 m+3)-th pixel row and the (4 m+4)-th pixel row on the HSD panel 140 are driven in a sequence of “the second scan line, the first scan line”. In the (2n+2)-th frame period, the gate driving circuit 130 drives the (4 m+1)-th pixel row and the (4 m+2)-th pixel row in a sequence of “the second scan line, the first scan line”, and drives the (4 m+3)-th pixel row and the (4 m+4)-th pixel row in a sequence of “the first scan line, the second scan line”. Namely, in the present embodiment, eight scan lines are taken as a cycle.

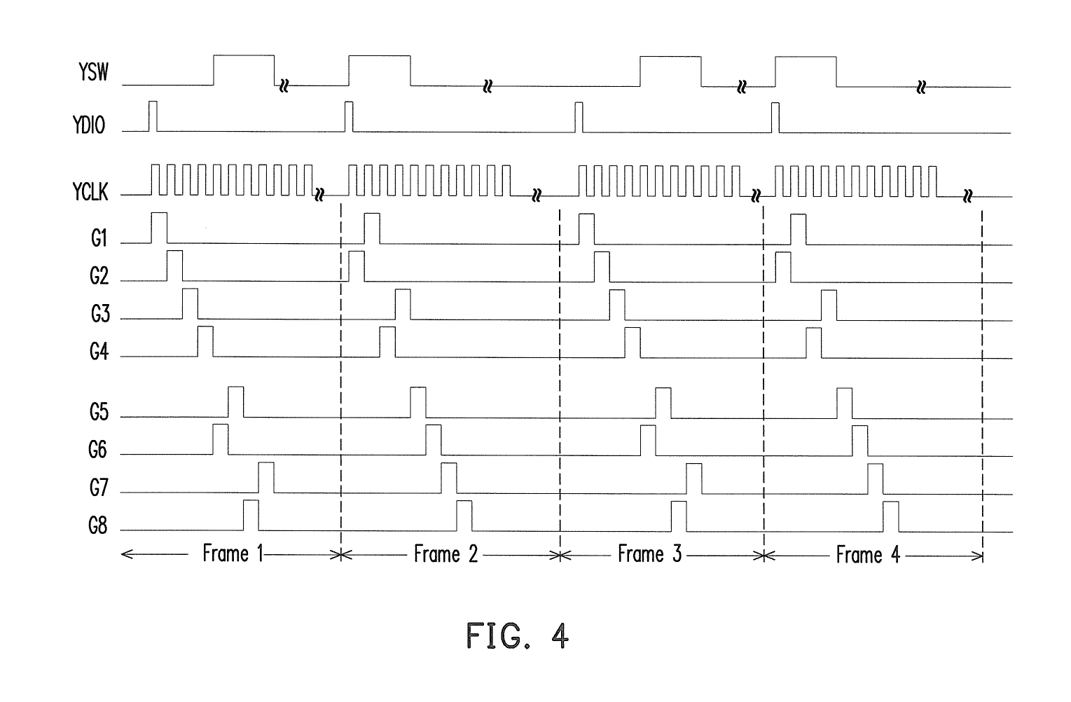

FIG. 4 is a timing diagram of signal waveforms of FIG. 1 according to an embodiment of the present invention. Referring to FIG. 1 and FIG. 4, in the (2n+1)-th frame (for example, a frame Frame1 or a frame Frame3 in FIG. 4), the gate driving circuit 130 provides the gate driving signal to the scan lines on the HSD panel 140 in a sequence of “G1, G2, G3, G4, G6, G5, G8, G7, . . . ”. Namely, the gate driving circuit 130 provides the gate driving signal to the scan lines on the HSD panel 140 in a sequence of “G(8m+1), G(8m+2), G(8m+3), G(8m+4), G(8m+6), G(8m+5), G(8m+8), G(8m+7)”. In the (2n+2)-th frame (for example, Frame2 or Frame4 in FIG. 4), the gate driving circuit 130 provides the gate driving signal to the scan lines on the HSD panel 140 in a sequence of “G(8m+2), G(8m+1), G(8m+4), G(8m+3), G(8m+5), G(8m+6), G(8m+7), G(8m+8)”.

### Third Embodiment

Similar to the first embodiment, the (2n+1)-th frame is regarded as the aforementioned first frame period, and the (2n+2)-th frame is regarded as the aforementioned second frame period. A difference between the present embodiment and the first embodiment is that six pixel rows (i.e. 12 scan lines) are taken as a cycle. In the first frame period, the gate driving circuit 130 drives a (6 m+1)-th pixel row, a (6 m+2)-th pixel row and a (6m+5)-th pixel row on the HSD panel 140 in a sequence of “the first scan line, the second scan line”, and drives a (6m+3)-th pixel row, a (6m+4)-th pixel row and a (6m+6)-th pixel row on the HSD panel 140 in a sequence of “the second scan line, the first scan line”. In the (2n+2)-th frame period, the gate driving circuit 130 drives the (6m+1)-th pixel row, the (6m+2)-th pixel row and the (6m+5)-th pixel row in a sequence of “the second scan line, the first scan line”, and drives the (6m+3)-th pixel row, the (6m+4)-th pixel row and the (6m+6)-th pixel row in a sequence of “the first scan line, the second scan line”.

Namely, in the (2n+1)-th frame, the gate driving circuit 130 provides the gate driving signal to the scan lines on the HSD panel 140 in a sequence of “G1, G2, G3, G4, G6, G5, G8, G7, G9, G10, G12, G11, . . . ”. Namely, the gate driving circuit 130 provides the gate driving signal to the scan lines on the HSD panel 140 in a sequence of “G(12m+1), G(12m+2), G(12m+3), G(12m+4), G(12m+6), G(12m+5), G(12m+8), G(12m+7), G(12m+9), G(12m+10), G(12m+12), G(12m+11)”. In the (2n+2)-th frame, the gate driving circuit 130 provides the gate driving signal to the scan lines on the HSD panel 140 in a sequence of “G(12m+2), G(12m+1), G(12m+3), G(12m+4), G(12m+5), G(12m+6), G(12m+7), G(12m+8), G(12m+10), G(12m+9), G(12m+11), G(12m+12)”.

### Fourth Embodiment

Similar to the first embodiment, a (2m+1)-th pixel row on the HSD panel 140 is regarded as the aforementioned a-th pixel row, and a (2m+2)-th pixel row is regarded as the aforementioned b-th pixel row. A difference between the present embodiment and the first embodiment is that a (4n+1)-th frame and a (4n+2)-th frame are regarded as the aforementioned first frame period, and a (4n+3)-th frame and a (4n+4)-th frame are regarded as the aforementioned second frame period. Namely, in the present embodiment, 4 frames are taken as a cycle.

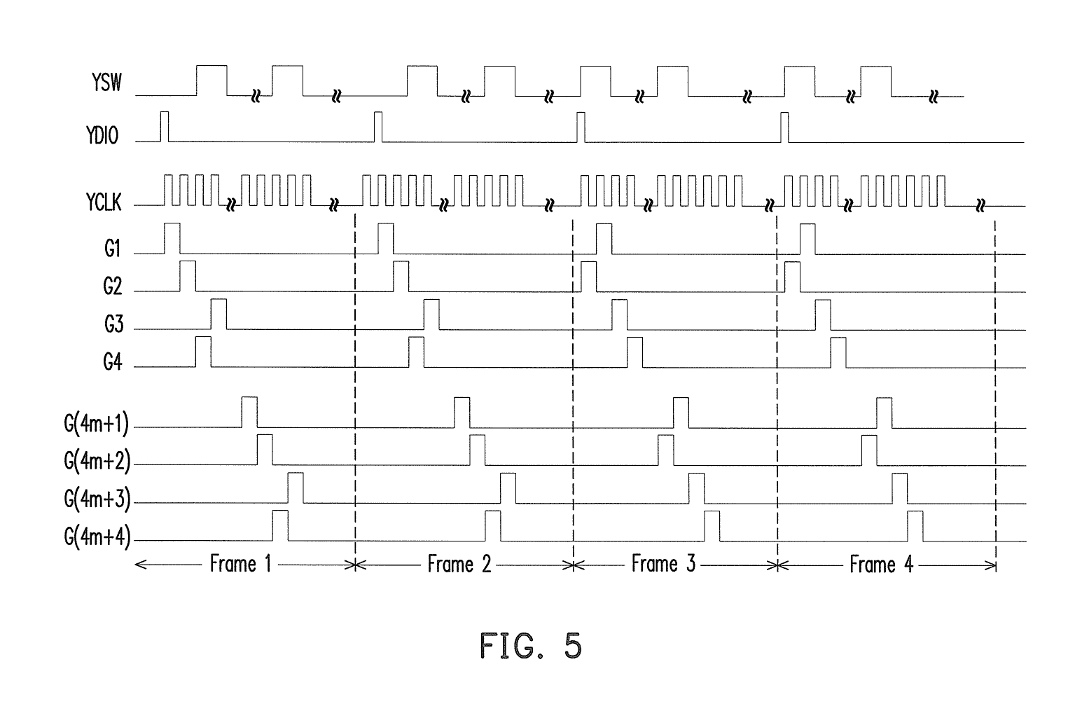

FIG. 5 is a timing diagram of signal waveforms of FIG. 1 according to an embodiment of the present invention. Referring to FIG. 1 and FIG. 5, in the (4n+1)-th frame and the (4n+2)-th frame (for example, the frame Frame1 and the frame Frame2 in FIG. 5), the gate driving circuit 130 provides the gate driving signal to the scan lines on the HSD panel 140 in a sequence of “G1, G2, G4, G3, G5, G6, G8, G7, . . . ”. Namely, the gate driving circuit 130 provides the gate driving signal to the scan lines on the HSD panel 140 in a sequence of “G(4m+1), G(4m+2), G(4m+4), G(4m+3)”. In the (4n+3)-th frame and the (4n+4)-th frame (for example, the frame Frame3 and the frame Frame4 in FIG. 5), the gate driving circuit 130 provides the gate driving signal to the scan lines on the HSD panel 140 in a sequence of “G(4m+2), G(4m+1), G(4m+3), G(4m+4)”.

Implementations of the present invention are not limited to the above embodiments, and those with ordinary skill in the art can deduce other implementations according to the above disclosure. According to the above embodiments, the uneven bright/dark pixels can be arranged in interlace in space, so as to avoid a situation that the bright pixels are all located at the odd (or even) columns, and accordingly a display defect of vertical bright/dark lines can be mitigated. Regarding a same pixel, the uneven bright/dark pixel is alternately presented on timing, so as to avoid presenting fixed bright/dark points on an image. Therefore, the display defect of the bright/dark lines occurred when the HSD pixel array is driven by the conventional technique can be mitigated. According to the driving method disclosed by the aforementioned embodiments, regarding the high resolution HSD panel, a width of the gate driving signal (i.e. a gate pulse width) can be suitably increased without preserving too much margin for data line delay or scan line delay. Comparatively, in the conventional technique, to preserve enough margin for the data line delay or the scan line delay, the gate pulse width has to be excessively reduced, which may cause insufficient pixel charging, so that an image contrast is insufficient.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pixel array, comprising:
a first pixel row, comprising a first scan line, a second scan line, a plurality of first pixels, and a plurality of second pixels, the first pixels and the second pixels are disposed between the first scan line and the second scan line in interlace;
a second pixel row, comprising a third scan line, a fourth scan line, a plurality of third pixels, and a plurality of fourth pixels, the third pixels and the fourth pixels are disposed between the third scan line and the fourth scan line in interlace;
a plurality of data lines, correspondingly coupled to the first pixels, the second pixels, the third pixels and the fourth pixels; and
a gate driving circuit, electrically coupled to the first scan line, the second scan line, the third scan line and the fourth scan line,
wherein in a first frame period, the gate driving circuit sequentially provides a driving signal to the first scan line, the second scan line, the fourth scan line and the third scan line, and in a second frame period, the gate driving circuit sequentially provides the driving signal to the second scan line, the first scan line, the third scan line and the fourth scan line.

2. The pixel array as claimed in claim 1, wherein the first scan line is an (8m+1)-th scan line of the pixel array, the second scan line is an (8m+2)-th scan line of the pixel array, the third scan line is an (8m+5)-th scan line of the pixel array, and the fourth scan line is an (8m+6)-th scan line of the pixel array, the gate driving circuit sequentially provides the driving signal to the (8m+1)-th scan line, the (8m+2)-th scan line, an (8m+3)-th scan line, an (8m+4)-th scan line, the (8m+6)-th scan line, the (8m+5)-th scan line, an (8m+8)-th scan line and an (8m+7)-th scan line in the first frame period, and sequentially provides the driving signal to the (8m+2)-th scan line, the (8m+1)-th scan line, the (8m+4)-th scan line, the (8m+3)-th scan line, the (8m+5)-th scan line, the (8m+6)-th scan line, the (8m+7)-th scan line and the (8m+8)-th scan line in the second frame period.

3. The pixel array as claimed in claim 1, wherein the first scan line is a (12m+1)-th scan line of the pixel array, the second scan line is a (12m+2)-th scan line of the pixel array, the third scan line is a (12m+5)-th scan line of the pixel array, and the fourth scan line is a (12m+6)-th scan line of the pixel array, the gate driving circuit sequentially provides the driving signal to the (12m+1)-th scan line, the (12m+2)-th scan line, a (12m+3)-th scan line, a (12m+4)-th scan line, the (12m+6)-th scan line, the (12m+5)-th scan line, a (12m+8)-th scan line, a (12m+7)-th scan line, a (12m+9)-th scan line, a (12m+10)-th scan line, a (12m+12)-th scan line and a (12m+11)-th scan line in the first frame period, and sequentially provides the driving signal to the (12m+2)-th scan line, the (12m+1)-th scan line, the (12m+4)-th scan line, the (12m+3)-th scan line, the (12m+5)-th scan line, the (12m+6)-th scan line, the (12m+7)-th scan line, the (12m+8)-th scan line, the (12m+10)-th scan line, the (12m+9)-th scan line, the (12m+11)-th scan line and the (12m+12)-th scan line in the second frame period.

4. The pixel array as claimed in claim 1, wherein the first frame period is a (4n+1)-th frame and a (4n+2)-th frame, and the second frame period is a (4n+3)-th frame and a (4n+4)-th frame, wherein n is an integer.

5. The pixel array as claimed in claim 4, wherein the first scan line is a (4m+1)-th scan line of the pixel array, the second scan line is a (4m+2)-th scan line of the pixel array, the third scan line is a (4m+3)-th scan line of the pixel array, and the fourth scan line is a (4m+4)-th scan line of the pixel array, wherein m is an integer.

6. The pixel array as claimed in claim 1, wherein the gate driving circuit comprises:
a shift register, comprising a first output terminal, a second output terminal, a third output terminal and a fourth output terminal;
a first switch, coupled to the first and the second output terminals of the shift register, the first scan line and the second scan line, wherein the first switch respectively couples the first and the second output ten finals of the shift register to the first scan line and the second scan line, or respectively couples the first and the second output terminals of the shift register to the second scan line and the first scan line according to a control signal; and
a second switch, coupled to the third and the fourth output terminals of the shift register, the third scan line and the fourth scan line, wherein the second switch respectively couples the third and the fourth output terminals of the shift register to the third scan line and the fourth scan line, or respectively couples the third and the fourth output terminals of the shift register to the fourth scan line and the third scan line according to the control signal.

7. A flat panel display, comprising:
a half source driving (HSD) panel, comprising a plurality of data lines, an a-th pixel row and a b-th pixel row, the a-th and the b-th pixel rows respectively comprising a plurality of first pixels, a plurality of second pixels, a first scan line and a second scan line, wherein the first pixels and the second pixels are disposed between the first scan line and the second scan line in interlace, the data lines are correspondingly coupled to the first pixels and the second pixels, a gate control terminal of the first pixels is coupled to the first scan line, and a gate control terminal of the second pixels is coupled to the second scan line;
a gate driving circuit, electrically coupled to the a-th pixel row and the b-th pixel row, wherein in a first frame period, the gate driving circuit drives the a-th pixel row in a sequence of “the first can line, the second scan line”, and drives the b-th pixel row in a sequence of “the second scan line, the first scan line”, and in a second frame period, the gate driving circuit drives the a-th pixel row in a sequence of “the second can line, the first scan line”, and drives the b-th pixel row in a sequence of “the first scan line, the second scan line”; and
a source driving circuit, coupled to the data lines, wherein the source driving circuit drives the data lines according to a timing of the gate driving circuit.

8. The flat panel display as claimed in claim 7, wherein the first frame period is a (2n+1)-th frame, and the second frame period is a (2n+2)-th frame, wherein n is an integer.

9. The flat panel display as claimed in claim 8, wherein the a-th pixel row is a (2m+1)-th pixel row, and the b-th pixel row is a (2m+2)-th pixel row, wherein m is an integer.

10. The flat panel display as claimed in claim 8, wherein the a-th pixel row is a (4m+1)-th pixel row, and the b-th pixel row is a (4m+3)-th pixel row, the gate driving circuit further drives a (4m+2)-th pixel row of the HSD panel in a sequence of “the first scan line, the second scan line”, and drives a (4m+4)-th pixel row of the HSD panel in a sequence of “the second can line, the first scan line” in the first frame period, and the gate driving circuit drives the (4m+2)-th pixel row in a sequence of “the second scan line, the first scan line”, and drives the (4m+4)-th pixel row in a sequence of “the first can line, the second scan line” in the second frame period.

11. The flat panel display as claimed in claim 8, wherein the a-th pixel row is a (6m+1)-th pixel row, and the b-th pixel row is a (6m+3)-th pixel row, the gate driving circuit further drives a (6m+2)-th pixel row and a (6m+5)-th pixel row of the HSD panel in a sequence of “the first scan line, the second scan line”, and drives a (6m+4)-th pixel row and a (6m+6)-th pixel row of the HSD panel in a sequence of “the second can line, the first scan line” in the first frame period, and the gate driving circuit drives the (6m+2)-th pixel row and the (6m+5)-th pixel row in a sequence of “the second scan line, the first scan line”, and drives the (6m+4)-th pixel row and the (6m+6)-th pixel row in a sequence of “the first can line, the second scan line” in the second frame period.

12. The flat panel display as claimed in claim 7, wherein the first frame period is a (4n+1)-th frame and a (4n+2)-th frame, and the second frame period is a (4n+3)-th frame and a (4n+4)-th frame, wherein n is an integer.

13. The flat panel display as claimed in claim 12, wherein the a-th pixel row is a (2m+1)-th pixel row, and the b-th pixel row is a (2m+2)-th pixel row, wherein m is an integer.

14. The flat panel display as claimed in claim 7, wherein the gate driving circuit comprises:
a shift register, comprising an (a+1)-th output terminal, an (a+2)-th output terminal, a (b+1)-th output terminal and a (b+2)-th output terminal;
a first switch, coupled to the (a+1)-th and the (a+2)-th output terminals of the shift register, the first and the second scan lines of the a-th pixel row, wherein the first switch respectively couples the (a+1)-th and the (a+2)-th output terminals of the shift register to the first and the second scan lines of the a-th pixel row, or respectively couples the (a+1)-th and the (a+2)-th output terminals of the shift register to the second and the first scan lines of the a-th pixel row according to a control signal; and
a second switch, coupled to the (b+1)-th and the (b+2)-th output terminals of the shift register, the first and the second scan lines of the b-th pixel row, wherein the second switch respectively couples the (b+1)-th and the (b+2)-th output terminals of the shift register to the first and the second scan lines of the b-th pixel row, or respectively couples the (b+1)-th and the (b+2)-th output terminals of the shift register to the second and the first scan lines of the b-th pixel row according to the control signal.

15. A driving method for a pixel array, wherein the pixel array comprises the pixel array as claimed in claim 1, the driving method comprising:
sequentially providing a driving signal to the first scan line, the second scan line, the fourth scan line and the third scan line in a first frame period; and
sequentially providing the driving signal to the second scan line, the first scan line, the third scan line and the fourth scan line in a second frame period.

16. The driving method for the pixel array as claimed in claim 15, wherein the first frame period is a (2n+1)-th frame, and the second frame period is a (2n+2)-th frame, wherein n is an integer.

17. The driving method for the pixel array as claimed in claim 16, wherein the first scan line is a (4m+1)-th scan line of the pixel array, the second scan line is a (4m+2)-th scan line of the pixel array, the third scan line is a (4m+3)-th scan line of the pixel array, and the fourth scan line is a (4m+4)-th scan line of the pixel array, wherein m is an integer.

18. The driving method for the pixel array as claimed in claim 16, wherein the first scan line is an (8m+1)-th scan line of the pixel array, the second scan line is an (8m+2)-th scan line of the pixel array, the third scan line is an (8m+5)-th scan line of the pixel array, and the fourth scan line is an (8m+6)-th scan line of the pixel array, and the driving method comprises:
sequentially providing the driving signal to the (8m+1)-th scan line, the (8m+2)-th scan line, an (8m+3)-th scan line, an (8m+4)-th scan line, the (8m+6)-th scan line, the (8m+5)-th scan line, an (8m+8)-th scan line and an (8m+7)-th scan line in the first frame period; and
sequentially providing the driving signal to the (8m+2)-th scan line, the (8m+1)-th scan line, the (8m+4)-th scan line, the (8m+3)-th scan line, the (8m+5)-th scan line, the (8m+6)-th scan line, the (8m+7)-th scan line and the (8m+8)-th scan line in the second frame period.

19. The driving method for the pixel array as claimed in claim 16, wherein the first scan line is a (12m+1)-th scan line of the pixel array, the second scan line is a (12m+2)-th scan line of the pixel array, the third scan line is a (12m+5)-th scan line of the pixel array, and the fourth scan line is a (12m+6)-th scan line of the pixel array, and the driving method comprises:
sequentially providing the driving signal to the (12m+1)-th scan line, the (12m+2)-th scan line, a (12m+3)-th scan line, a (12m+4)-th scan line, the (12m+6)-th scan line, the (12m+5)-th scan line, a (12m+8)-th scan line, a (12m+7)-th scan line, a (12m+9)-th scan line, a (12m+10)-th scan line, a (12m+12)-th scan line and a (12m+11)-th scan line in the first frame period; and
sequentially providing the driving signal to the (12m+2)-th scan line, the (12m+1)-th scan line, the (12m+4)-th scan line, the (12m+3)-th scan line, the (12m+5)-th scan line, the (12m+6)-th scan line, the (12m+7)-th scan line, the (12m+8)-th scan line, the (12m+10)-th scan line, the (12m+9)-th scan line, the (12m+11)-th scan line and the (12m+12)-th scan line in the second frame period.

20. The driving method for the pixel array as claimed in claim 15, wherein the first frame period is a (4n+1)-th frame and a (4n+2)-th frame, and the second frame period is a (4n+2)-th frame and a (4n+4)-th frame, wherein n is an integer.

21. The driving method for the pixel array as claimed in claim 20, wherein the first scan line is a (4m+1)-th scan line of the pixel array, the second scan line is a (4m+2)-th scan line of the pixel array, the third scan line is a (4m+3)-th scan line of the pixel array, and the fourth scan line is a (4m+4)-th scan line of the pixel array, wherein m is an integer.
